(19) United States
(12) Patent Application Publication
(10) Pub. No.: US 2026/0092481 A1
(43) Pub. Date: Apr. 2, 2026

(54) TRANSLATIONAL-ROTATIONAL FITTING AND FURNITURE OR HOUSEHOLD APPLIANCE ELEMENT

(71) Applicant: PAUL HETTICH GMBH & CO. KG, Kirchlengern (DE)

(72) Inventors: Andreas MONTECCHIO, Bad Salzuflen (DE); Christoph KURSAWE, Bissendorf (DE); Waldemar PETKER, Bünde (DE); Sören KLÜTER, Bad Oeynhausen (DE)

(21) Appl. No.: 19/113,177

(22) PCT Filed: Sep. 19, 2023
(86) PCT No.: PCT/EP2023/075754

§ 371 Date: Mar. 19, 2025

(30) Foreign Application Priority Data
Sep. 20, 2022 (DE) 10 2022 124 145.9

(51) Int. Cl. E05D 7/04; E05D 3/18

(52) U.S. Cl. CPC E05D 7/0407; E05D 3/18; E05D 2007/0469; E05D 2007/0484; E05D 2007/0492

(57) ABSTRACT

A translational-rotational fitting at least partially positively guides simultaneous translational-rotational movement of a first body relative to a second body in one of two possible opposite directions of rotation and in a predetermined direction of translation. A first fitting part is coupled to the first body and a second fitting part is coupled to the second body, which can be moved simultaneously in translation and rotation relative to the first fitting part. An adjustment arrangement, actuatable by an auxiliary tool, is on the first fitting part for independent alignment of the first fitting part relative to the first body in at least one of two mutually perpendicular adjustment directions in the plane of the plane spanned by the direction of translation and the directions of rotation by a limited adjustment dimension.

### BACKGROUND AND SUMMARY OF THE INVENTION

Exemplary embodiments of the present invention relate to a translational-rotational fitting and to a furniture or household appliance element.

Generic translational-rotational fittings, such as those known from DE 10 2019 109 866 A1, which are used for the simultaneous translational and rotational movement of a first body relative to a second body, for example in the form of a shelf accommodated in a furniture body, have proven themselves in practice. Such translational-rotational fittings are usually fixed to the first body with a first fitting part.

Depending on the design of the furniture or household appliance element, it may be necessary to align the translational-rotational fitting in its mounting plane, which can be relatively time-consuming in the case of direct mounting on the first furniture body, depending on the assembly progress of the furniture, as individual components may have to be dismantled again before alignment.

Exemplary embodiments of the present invention are directed to a translational-rotational fitting with which alignment in the horizontal plane is still possible in a simple manner, even subsequently, and to provide an easily adjustable furniture or household appliance element with such a translational-rotational fitting.

A translational-rotational fitting according to the invention for at least partially positively guided simultaneous translational-rotational movement of a first body relative to a second body in one of two possible opposite directions of rotation and in a predetermined direction of translation has a first fitting part coupled to the first body and a second fitting part coupled to the second body and capable of simultaneous translational and rotational movement relative to the first fitting part.

At least one adjustment arrangement, which can be actuated by an auxiliary tool, is arranged on the first fitting part for independent alignment of the first fitting part relative to the first body in at least one of two mutually perpendicular adjustment directions in the plane of the plane spanned by the direction of translation and the directions of rotation by a limited adjustment dimension.

With such an adjustment arrangement arranged on the translational-rotational fitting, it is possible to align the translational-rotational fitting between the first and second body in the horizontal plane in a simple manner.

In addition, the adjustment with the adjustment arrangement also enables an aperture gap to be adjusted in a simple manner.

According to a preferred embodiment, the adjustment arrangement of the translational-rotational fitting has a base plate arranged on the first body and a carrier plate arranged on the first fitting part.

According to a preferred further development, the adjustment arrangement has a first slider held displaceably in a recess in the base plate in the second adjustment direction and a second slider coupled to the first slider and arranged displaceably relative to the base plate in the first adjustment direction.

A fixed but pivotably coupled first lever with the first slider for adjusting the carrier plate relative to the base plate in the first adjustment direction and a fixed but pivotably coupled second lever with the base plate for adjusting the carrier plate relative to the base plate in the second adjustment direction is also part of this preferred further development of the adjustment arrangement.

Furthermore, the adjustment arrangement has a plurality of guide bolts held stationary on the second slider and which extend through elongated holes in the base plate extending in the second adjustment direction into elongated holes in the carrier plate extending in the first adjustment direction, the first lever and the second lever having a receptacle for inserting and/or fixing the auxiliary tool.

According to a further preferred embodiment, the first lever can be latched to the first slider by means of a latching element and the second lever can be latched to the base plate by means of a latching element in order to lock the adjustment arrangement.

According to a preferred further development, a respective latching element is resiliently mounted in the area of the respective receptacle of the first and second lever, so that the latching element is pushed or pulled into a latching position without external force.

In a preferred embodiment, latching teeth are formed on the first slider and in a region of the base plate on which the receptacle of the second lever for inserting the auxiliary tool is positioned, which teeth can be brought into engagement with latching teeth of a latching strip of the latching element, the latching strip being out of engagement with the latching teeth when the auxiliary tool is inserted into the receptacle of the first or second lever.

This allows the locking of the respective lever to be released simply by inserting the auxiliary tool when the intended adjustment is made.

In an alternative embodiment of the translational-rotational fitting according to the invention, the adjustment arrangement has an intermediate plate arranged between the base plate and the carrier plate as well as two base holders attached to the base plate, in each of which a sliding element is held so as to be displaceable in one of the adjusting directions. The carrier plate is slidably held on the intermediate plate in a first of the adjusting directions and the intermediate plate is slidably held on the base plate in a second of the adjusting directions.

The sliding elements have a receptacle for inserting and/or fixing the auxiliary tool, with the sliding element held in the first base holder being coupled in a stationary manner to the intermediate plate or the carrier plate and the sliding element held in the second base holder being coupled in a stationary manner to the other of the intermediate plate or the carrier plate.

Such an alternative adjustment arrangement also enables the second object coupled to the carrier plate to be aligned in a simple manner.

In a preferred embodiment of this adjustment arrangement, the sliding elements have at least one web that is aligned perpendicular to the intended adjustment direction and projects positively into a web receptacle of the intermediate plate or the carrier plate.

This allows the intermediate plate (together with the carrier plate) to be moved relative to the base plate or the carrier plate to be moved relative to the intermediate plate simply by moving the sliding element.

In this design variant of the adjustment arrangement, the sliding elements have a clamping web that protrudes into a clamping device accommodated in the respective base holder to lock the carrier plate in a preset position.

This enables infinitely variable adjustment of the adjustment arrangement.

In a preferred further development, each of the clamping devices has two ball carriers, each with a ball held therein, which are held in a respective recess of the base holder so as to be displaceable in the respective adjusting direction.

The balls are each mounted in a conical section of the respective recess and can be moved by sliding the ball carriers from a spring-loaded clamping position that clamps the clamping web of the respective sliding element to a release position that does not clamp the clamping web of the respective sliding element and in which the balls release the clamping web.

According to a further alternative embodiment, the clamping of the sliding elements can be designed in such a way that the sliding elements can be clamped to the base holder by means of a clamping element.

The clamping element is held here in a clamping element receptacle of the base holder so that it can be displaced in the adjusting direction, whereby the sliding element presses against a friction edge of the base holder in a direction perpendicular to the adjusting direction.

In this design variant, the sliding element must therefore be pushed forward a little perpendicular to the direction of displacement in the direction of insertion using the auxiliary tool in order to release the clamping by the clamping element and then carry out the displacement movement in the desired adjustment direction in this advanced position.

According to an alternative embodiment, each of the clamping devices has two clamping body carriers each with a clamping body held therein, which are held displaceably in the respective adjusting direction in a respective recess of the base holder, wherein the clamping bodies are each mounted in a conical section of the respective recess and can be moved by displacing the clamping body carriers from a clamping position clamping the clamping web of the respective sliding element into a release position not clamping the clamping web of the respective sliding element.

The clamping bodies are preferably designed as cylinders, rollers, sliding pieces or wedges.

In a further preferred embodiment, the auxiliary tool has an actuating tongue that can be inserted into the receptacles of the first or second lever.

In a first preferred embodiment, the actuating tongue of the auxiliary tool inserted into the respective holder can be pulled out of the respective holder again.

This means that the auxiliary tool can be easily removed from the fitting once the fitting has been adjusted.

In an alternative embodiment, the actuating tongue of the auxiliary tool inserted into the respective holder is fixed in the respective holder.

A variant in which the actuating tongue of the auxiliary tool is coupled to a handle via a folding mechanism is particularly preferred.

This means that the auxiliary tool is always available. Thanks to the folding mechanism, it can be easily folded into a slot between the top or bottom edge of a front or side panel of the second body and a base or ceiling of the first body when not in use.

According to a further preferred embodiment, the first and second fitting parts are designed as first and second fitting plates which, for simultaneous translational-rotational movement, each have running grooves in bearing surfaces facing each other, in which rolling elements are guided.

An alternative translational-rotational fitting for the at least partially positively guided simultaneous translational-rotational movement of a first body relative to a second body in one of two possible opposite directions of rotation and in a predetermined direction of translation has a guide element for the simultaneous translational-rotational movement on the first fitting part, which can be moved in a curved guide track arranged on or in the second fitting part.

The furniture or household appliance element according to the invention has a first body and a second body movable relative thereto, as well as a translational-rotational fitting by means of which the second body can be moved relative to the first body in a predetermined direction of translation and simultaneously in one of two possible opposite directions of rotation.

The translational-rotational fitting is designed as described above.

### BRIEF DESCRIPTION OF THE DRAWING FIGURES

In the following, preferred embodiments of the invention are explained in more detail with reference to the accompanying drawings, wherein:

FIG. 1 shows a schematic perspective view of a furniture element with a first, non-translationally and rotationally movable first body and a translationally and rotationally movable second body in a closed position,

FIG. 2a shows a schematic isometric representation of a section of the furniture or household appliance element with a translational-rotational fitting arranged between a base of the first body and a second body and an adjustment arrangement for aligning the translational-rotational fitting and thus the second body relative to the first body,

FIG. 2b shows a side view of the furniture or household appliance element with the auxiliary tool inserted into the adjustment arrangement,

FIG. 3a shows an isometric exploded view of an adjustment arrangement fixed to the first body, essential components of the translational-rotational fitting and the second body to be fixed to a second fitting part designed as a plate, here in schematic form as a simple plate,

FIG. 3b shows an isometric exploded view of an adjustment arrangement fixed to the first body, essential components of an alternative translational-rotational fitting and the second body to be fixed to the second fitting part, here in schematic form as a simple plate,

FIG. 4 shows an isometric exploded view of a first embodiment of an adjustment arrangement,

FIG. 5a shows an isometric representation of the adjustment arrangement fixed to the first body and an auxiliary tool inserted into the adjustment arrangement,

FIG. 5b shows an isometric representation of the adjustment arrangement secured to the first body and an auxiliary tool inserted into the adjustment arrangement and secured to the first body so that it can be folded in, with the handle folded out,

FIG. 5c shows an adjustment arrangement corresponding to FIG. 5a with the handle folded in,

FIG. 6 shows an isometric view from below of the adjustment arrangement shown in FIG. 4,

FIG. 7 shows an enlarged section of the adjustment arrangement according to FIG. 6 showing the locking web and locking teeth for locking the first lever,

FIGS. 8-14 show representations of the adjustment arrangement according to FIG. 6 below in different adjustment positions,

FIG. 15 shows an isometric representation of a second design variant of an adjustment arrangement of the translational-rotational fitting,

FIG. 16 shows an isometric view of the adjustment arrangement shown in FIG. 15 from below (with the first body hidden),

FIG. 17 shows an exploded view of the adjustment arrangement according to FIGS. 15 and 16,

FIG. 18 shows an additional exploded view of a section of the adjustment arrangement to show the components required for clamping,

FIGS. 19a-19d show top views from below of the adjustment arrangement according to FIG. 15 in different adjustment positions,

FIGS. 20a and 20b show isometric detailed views of the adjustment arrangement to show a displacement movement using the auxiliary tool,

FIGS. 21a-25b show top views or sectional views through the detail of the adjustment arrangement shown in FIGS. 20a and 20b to show the clamping or release of the sliding element,

FIG. 26 shows an isometric enlargement of a section of an alternative embodiment of a sliding element and a clamping element for locking it,

FIG. 27 shows an isometric exploded view of the adjustment arrangement according to FIG. 26, and

FIGS. 28-31 show top views of the section of the adjustment arrangement shown in FIG. 26 with differently positioned sliding element.

### DETAILED DESCRIPTION

In the following description of the figures, terms such as top, bottom, left, right, front, rear, etc. refer exclusively to the exemplary representation and position of the adjustment arrangement, the body, the translational-rotational fitting, the base plate, carrier plate, slider, lever and the like selected in the respective figures. These terms are not to be understood restrictively, i.e., these references may change due to different working positions or the mirror-symmetrical design or the like.

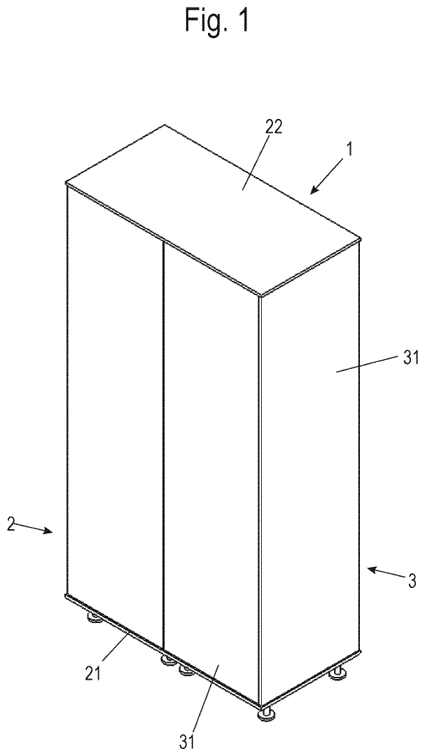

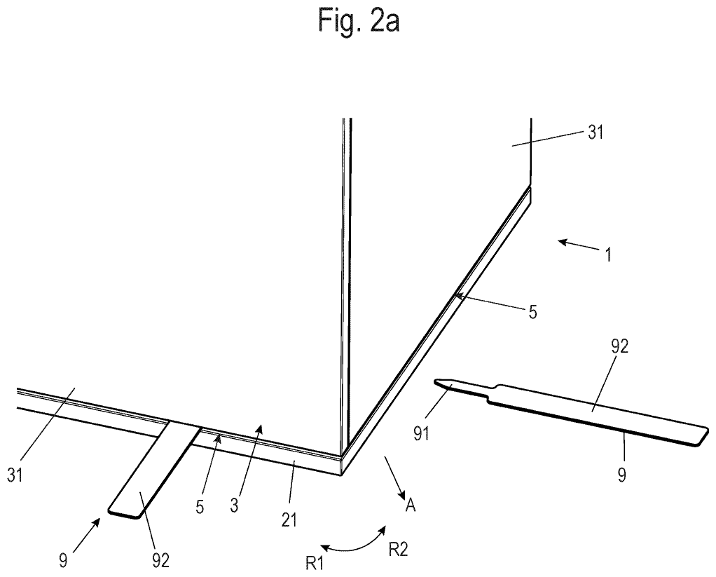

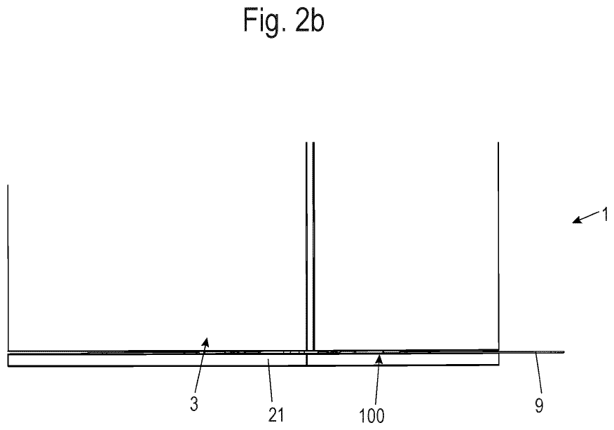

In FIGS. 1, 2a and 2b, the reference sign 1 designates a furniture or household appliance element as a whole. The furniture or household appliance element 1 here has a first body 2 with a base 21 and a ceiling 22, and a second body 3 moveable relative to this base, wherein the base 21 and the top of the first body 2 overlap the second body 3.

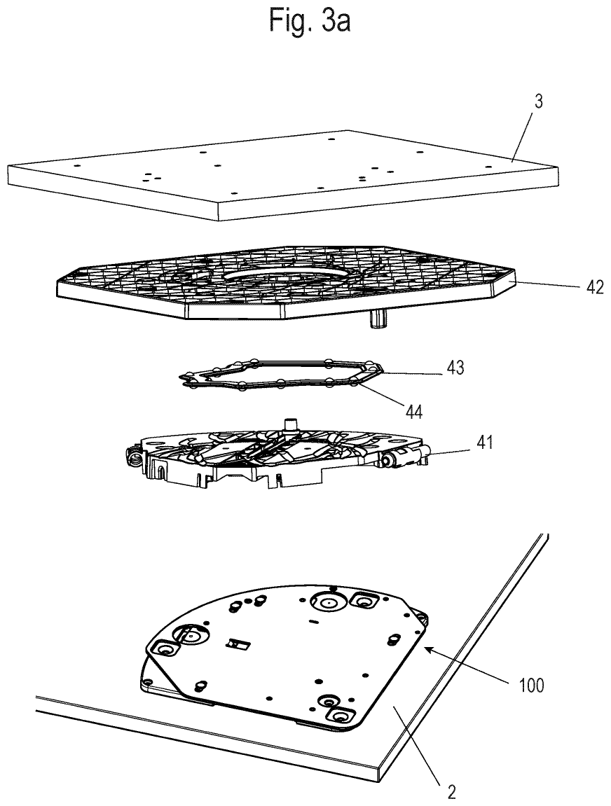

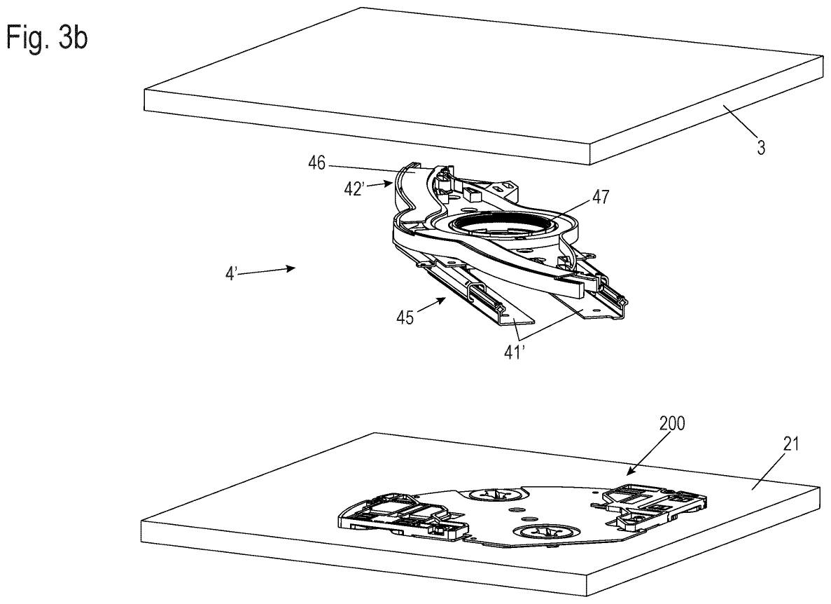

To move the second body 3, shown in FIG. 3a by a simple plate, relative to the first body 2, a translational-rotational fitting 4 is provided between the first body 2 and the second body 3 with a first fitting part 41 designed as a fitting plate, a second fitting part 42 also designed as a fitting plate, a plurality of rolling elements 44 and a rolling element cage 43, which holds the rolling elements 44 relative to one another in a predetermined position. The first fitting part 41 and the second fitting part 42 advantageously have running grooves for the rolling elements.

Alternatively, the superimposed translational-rotational movement of the second body 3, also shown in FIG. 3b by a simple plate, relative to the first body 2 can be realized by a translational-rotational fitting 4′ with a first fitting part 41, a second fitting part 42, a linear guide 45, a guide track 46, a guide element, and a swivel head 47. A ball head or similar can also be used instead of the swivel head 47. The first fitting part 41 is designed here in the form of retaining webs of two guide rails of the linear guide 45, on which running rails can be displaced in the direction of translation A. It is also conceivable, for example, that the first fitting part 41, to which the guide rails are attached or molded, has a plate-shaped design. A linear guide 45 with only one or more than two guide rails is also conceivable.

Furthermore, as can be seen in FIG. 3a or FIG. 3b, an adjustment arrangement 100 or 200 is attached to the first body 2, the carrier plate 120 of which, as will be explained below, can be adjusted relative to a base plate 110 in a horizontal plane and which can be fixed in a stationary position on the first fitting part 41 of the translational-rotational fitting 4, 4′ in order to be able to align the translational-rotational fitting 4, 4′ in the horizontal x-y plane after mounting the adjustment arrangement 100 or 200 and the translational-rotational fitting 4, 4′ between the first body 2 and the second body 3 in the horizontal x-y plane. The adjustment in the horizontal x-y plane can be made possible in the x-direction or in the y-direction, preferably an adjustment is made possible both in the x-direction or in the y-direction and described below.

The translational-rotational fitting 4, 4′ is characterized by the fact that the second body 3 can be moved relative to the first body 2 in a partially constrained, simultaneous translational-rotational movement relative to the first body 2, namely in one of two possible opposite directions of rotation R1, R2 and in a predetermined direction of translation A, as also described by way of example in DE 10 2019 109 866 A1.

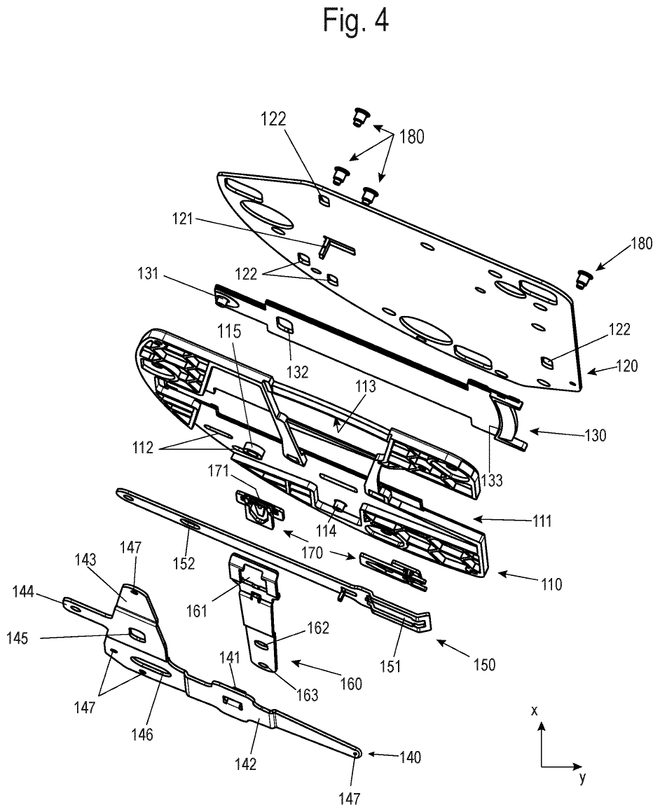

A first embodiment variant of the alignment of the translational-rotational fitting 4, 4′ in the x-y plane is shown in FIG. 4 in an exploded view.

As can be seen here, this first embodiment of the adjustment arrangement 100 has a base plate 110 that can be fastened to the first body 2 and a carrier plate 120 that can be fastened to the first fitting part 41 of the translational-rotational fitting 4, 4′.

The base plate 110 has a slider receptacle 111 in which a first slider 130 is accommodated, which is held displaceably relative to the base plate 110 in the second adjusting direction y.

Furthermore, a second slider 140 arranged on the base plate 110 and also displaceable relative to the base plate 110 in the second actuating direction y is provided. For guidance in the second actuating direction y, a guide cylinder 115 is arranged on the base plate 110, which projects into an elongated hole 146 in the second slider 140 extending in the second actuating direction y.

This second slider 140 is essentially L-shaped here, with a first leg 142 and a second leg 143, which is aligned approximately perpendicular to the first leg 142.

A tongue 144 with a bore extends from the second leg 143 approximately halfway along the second leg 143, in which a pivot pin 131 of the first slider 130 is received, so that when the first slider 130 is moved in the second positioning direction y, the second slider 140 also moves.

Furthermore, the adjustment arrangement 100 has a first lever 150, which is coupled in a stationary but pivotable manner to the first slider 130, for adjusting the carrier plate 120 relative to the base plate 110 in the first adjustment direction x, and a second lever 160, which is coupled in a stationary but pivotable manner to the base plate 110, for adjusting the carrier plate 120 relative to the base plate 110 in the second adjustment direction y.

A plurality of stationary guide bolts 180 are attached to the second slider 140 in bores 147 provided for this purpose, which extend through elongated holes 112 of the base plate 110 extending in the second positioning direction y into elongated holes 122 of the carrier plate 120 extending in the first positioning direction x.

The first lever 150 and the second lever 160 each have a receptacle 151, 161 for inserting and/or fixing an auxiliary tool 9.

The auxiliary tool 9 is designed as a flat component and has a handle 92 and an actuating tongue 91. This enables the auxiliary tool 9, as shown in FIGS. 2a and 2b, to be inserted through a slot 5 remaining between an upper or lower edge of a front or side panel 31 of the second body 3 and a base 21 or a ceiling 22 of the first body 2 in a closed position of the second body 3 shown in FIGS. 1, 2a and 2b, and thus the adjustment arrangement 100 is accessible in any position of the second body and in particular in the closed position of the second body.

Horizontal alignment of the second body 3 relative to the first body 2 in the closed position is particularly advantageous, as this makes it possible to adjust a joint pattern in the closed position of the furniture or household appliance element 1 without having to dismantle or move parts for accessibility for adjustment. Another advantage is that it is possible to check immediately whether the adjustment has produced the desired result.

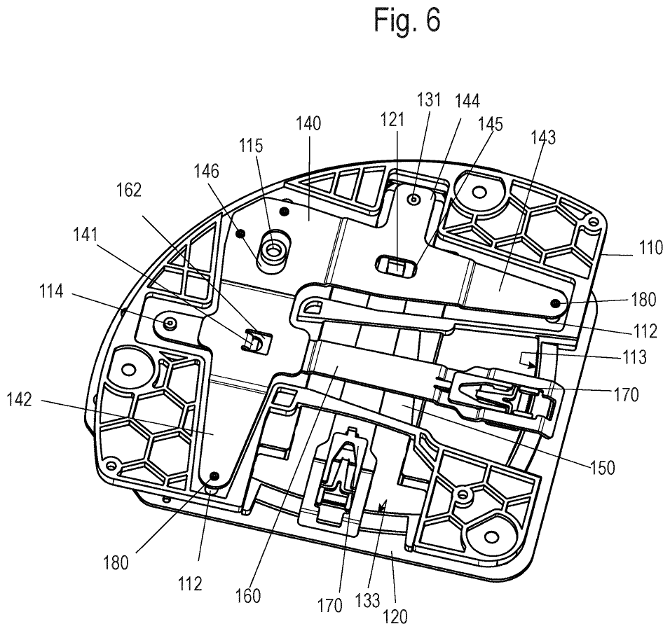

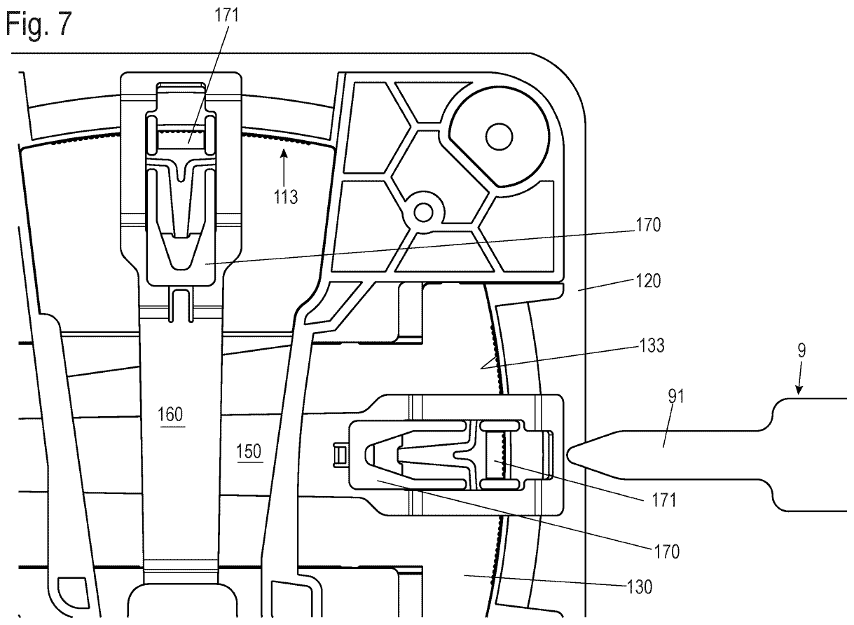

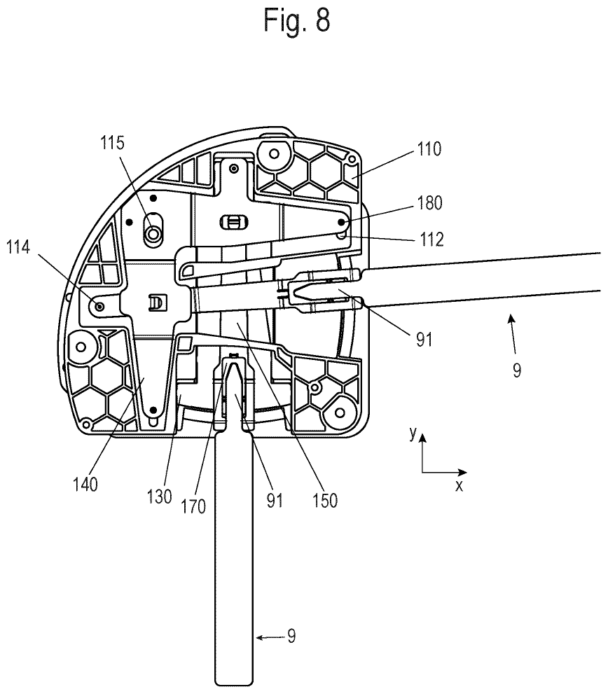

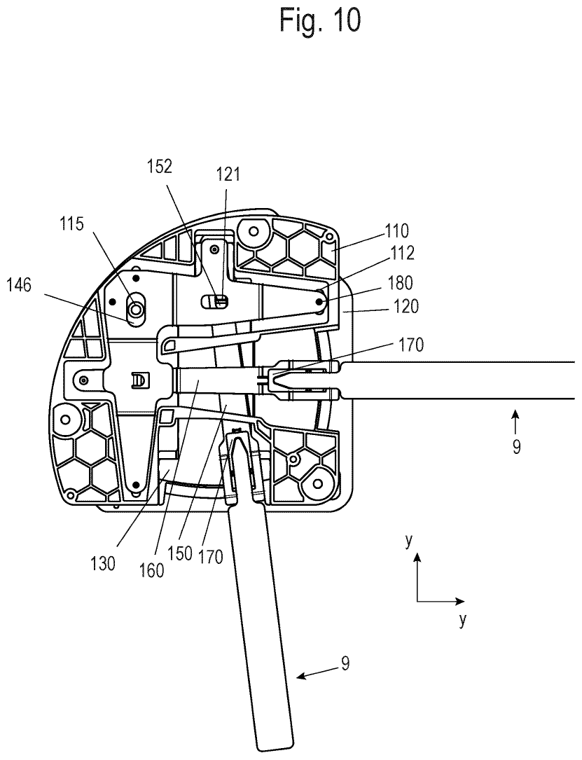

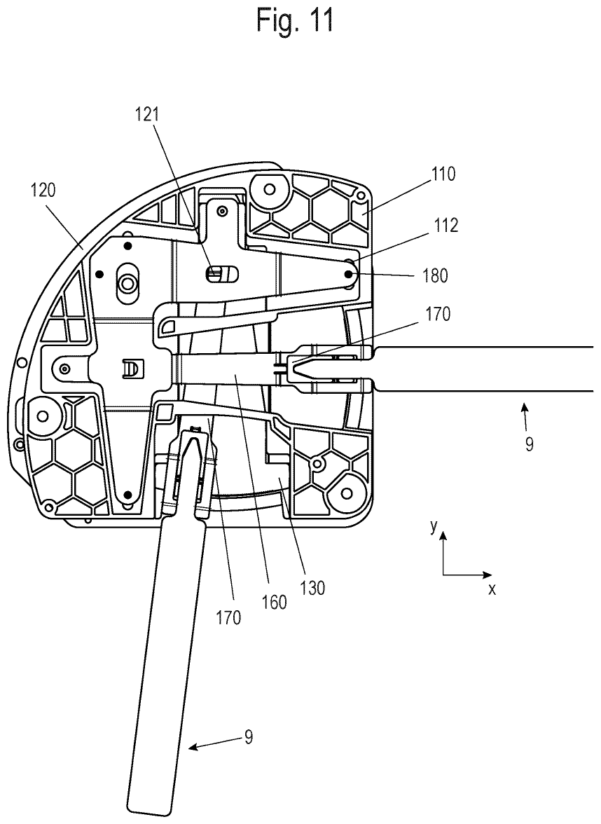

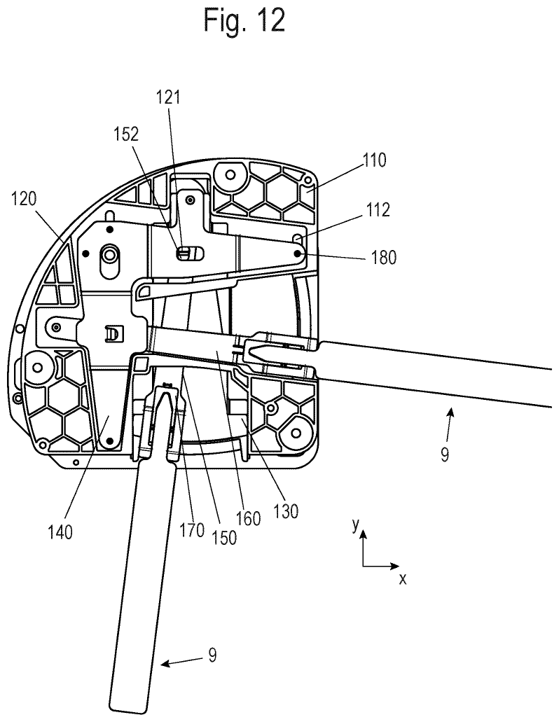

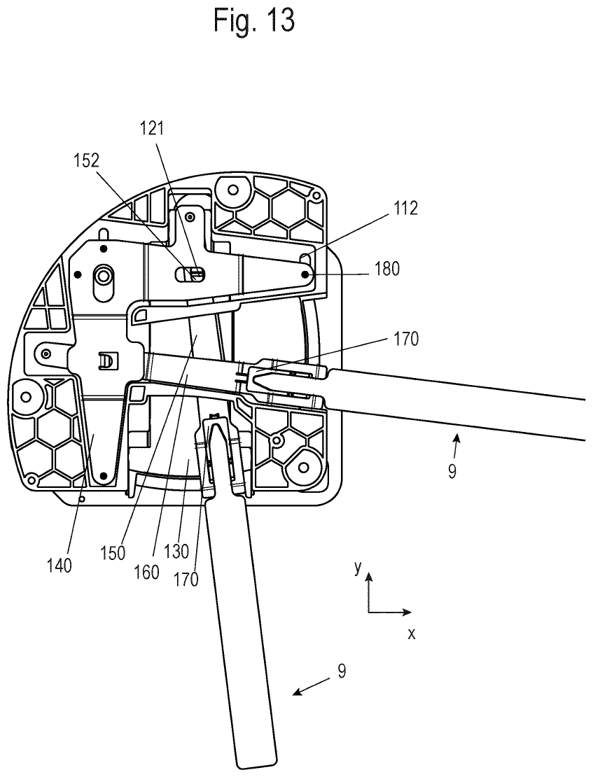

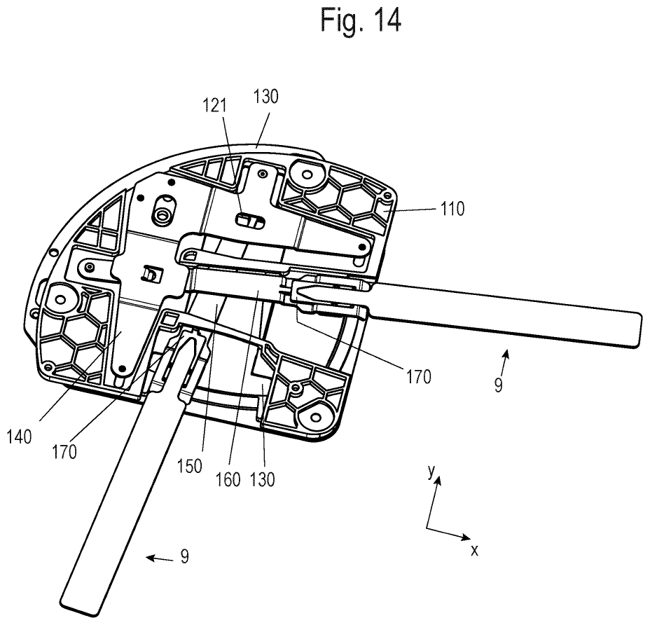

In the inserted state of the respective auxiliary tool 9, the side edges extending in the longitudinal direction of the auxiliary tool 9 of an actuating tongue 91 that can be inserted into the receptacles 151, 161 are aligned parallel to the side walls of the receptacle 151, 161, as can be seen in FIG. 8 as an example. In the preferred embodiment according to FIGS. 4-14, these side edges of the actuating tongue 91 are in contact with the side edges of a latching element 170, which serves to lock the adjustment arrangement 100, i.e., the first lever 150 and the second lever 160.

The latching elements 170 are inserted in the receptacle 151, 161 of the first lever 150 or the second lever 160.

To adjust the carrier plate 120 in the first adjustment direction x or the second adjustment direction y, the levers 150, 160 are rotated around their respective pivot points using the auxiliary tools.

The pivot pin 131 of the first slider 130, which projects into a pin receptacle 153 in the region of an end of the first lever 150 remote from the receptacle 151, serves here as the pivot point of the first lever 150.

A pivot pin 114, which is molded onto the base plate 110, serves as the pivot point of the second lever 160.

To adjust the carrier plate 120 in the first adjusting direction x, a driver web 121 projects from the carrier plate 120 through an elongated hole 132 in the first slider 130 extending in the first adjusting direction x into an elongated hole 152 of the first lever 150 extending in the second adjusting direction y and an elongated hole 145 in the second slider 140.

In the assembled state, the side edges of this driver web 121 are in contact with the side longitudinal edges of the elongated hole 152 of the first lever 150, so that by pivoting the first lever 150 with the pivoting movement, the elongated hole 152 moves in the first adjustment direction and in doing so carries the driver web 121 and thus the carrier plate 120 in the first adjustment direction x.

As can also be seen in FIG. 4, a driver web 141 protrudes from the second slider 140 into an elongated hole 162 of the second lever 160 extending in the first positioning direction x.

Accordingly, when the second lever 160 is pivoted via the driver web 141, the side edges of which rest against the longitudinal side edges of the elongated hole 162 of the first lever 160, the second slider 140 is also moved in the second positioning direction y (relative to the base plate 110).

The latching elements 170 are provided to lock the adjustment arrangement 100 in a desired position.

A respective latching element 170 is fixed in the area of the respective receptacle 151, 161 of the first and second lever 150, 160.

To lock the levers 150, 160 in a predetermined position, latching teeth 113, 133 are formed on the first slider 130 and in a region of the base plate 110 on which the receptacle 161 of the second lever 160 for inserting the auxiliary tool 9 is positioned, which teeth can be brought into engagement with latching teeth of a latching strip 171 of the latching element 170.

The latching strip 171 is out of engagement with the latching teeth 113, 133, the base plate 110 or the first slider 130 when the auxiliary tool 9 is inserted into the receptacle 151, 161 of the first or second lever 150, 160.

The actuating tongue 91 of the auxiliary tool 9 pushes the latching strip 171 of the respective latching element 170 out of the plane of the latching teeth 113, 133 in the position inserted into the receptacle 151, 161.

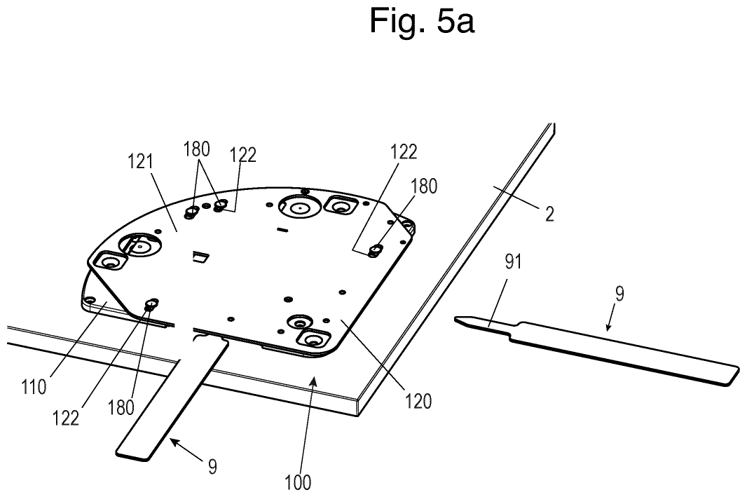

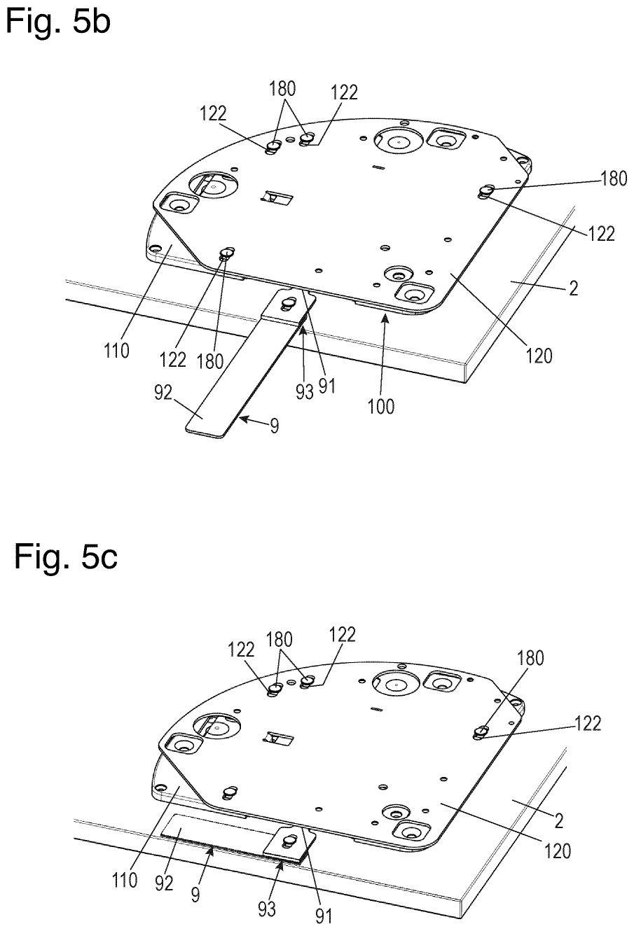

FIGS. 5a-5c show an example of an adjustment arrangement 100 mounted on a first body 2, in which one of two auxiliary tools 9 is inserted into one of the receptacles 151, 161 of the first or second lever 150, 160.

The position of the guide bolts 180 in the elongated holes 122 of the carrier plate 120 shows that the carrier plate 120 is in a neutral position in the first positioning direction x, which can also be recognized by the central position of the auxiliary tool 9.

Instead of auxiliary tools 9, which can be inserted into the receptacles 151, 161 provided for this purpose as required, the actuating tongues 91 of the auxiliary tools 9 are permanently fixed in the receptacles 151, 161 in an alternative embodiment variant, as shown in FIGS. 5a and 5b.

In this embodiment, the auxiliary tool 9 is designed with a handle 92 that can be folded relative to the actuating tongue 91. For this purpose, the handle 92 is connected via a folding mechanism 93 to the actuating tongue 91 permanently accommodated in the respective receptacle 151, 161.

This makes it possible to fold the handle 92 into the slot 5 when not in use, as shown in FIG. 5c. To operate the auxiliary tool 9, the second furniture part can preferably be pushed open or rotated slightly relative to the first furniture part 2 in order to gain access to the handle 92.

Alternatively, it is also conceivable to additionally provide the folding mechanism with a push-to-open mechanism so that, if necessary, by pressing the side edge of the handle 92 close to the outer edge of the first body 2 further into the slot 5, the handle 92 folds out from the position shown in FIG. 5c into the position shown in FIG. 5b by triggering the push-to-open mechanism, thus enabling the first fitting part 41 to be adjusted.

FIG. 8 shows an example of an adjusted position of the carrier plate 120 by pivoting the second lever 160, which is accompanied by a displacement of the carrier plate 120 in the second positioning direction y.

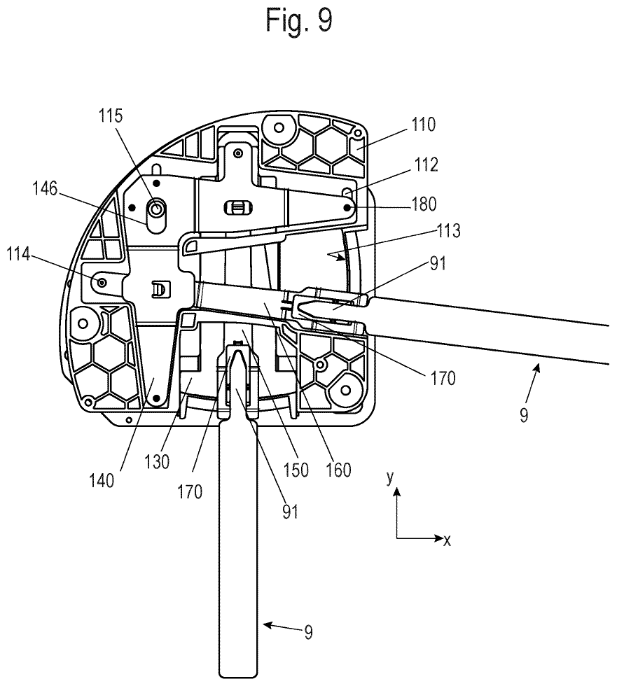

FIGS. 9 to 14 show further different adjustment positions of the carrier plate 120 relative to the base plate 110 and their actuation by operating the corresponding levers 150, 160.

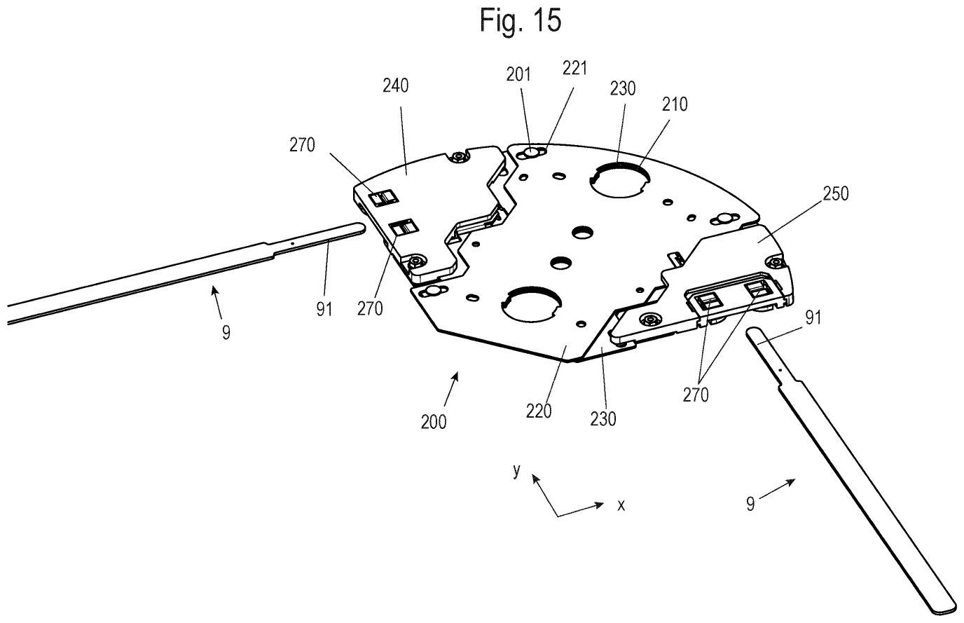

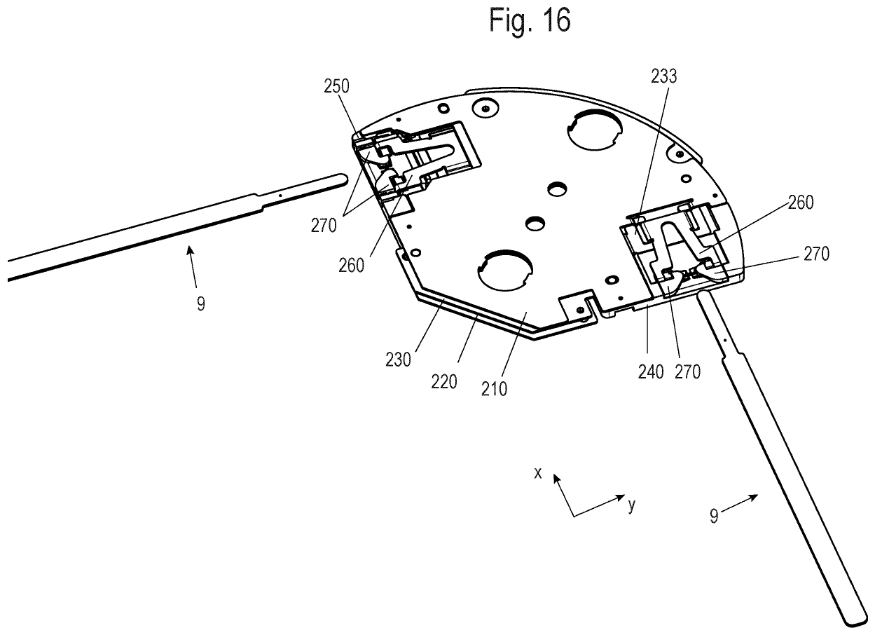

An alternative preferred embodiment of an adjustment arrangement according to the invention is shown in FIGS. 15 to 25.

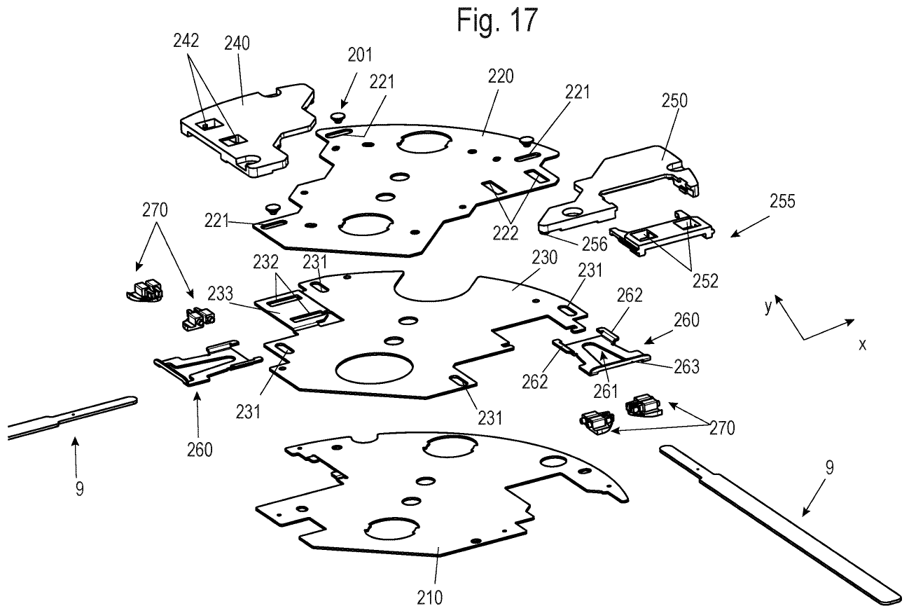

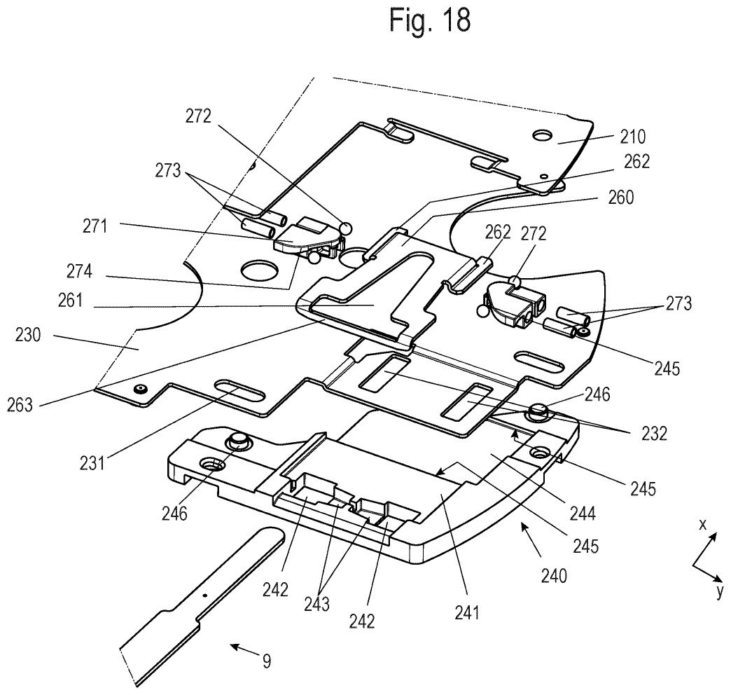

As shown in particular in the exploded views according to FIGS. 17 and 18, this embodiment of the adjustment arrangement 200 also has a base plate 210 that can be fastened to the first body 2 and a carrier plate 220 that can be fastened to the second body 3.

In contrast to the adjustment arrangement 100 shown in FIGS. 1 to 14, this adjustment arrangement 200 has an intermediate plate 230 arranged between the base plate 210 and the carrier plate 220 in order to enable displacement in the two adjustment directions x, y.

The intermediate plate 230 thus enables, on the one hand, an adjustment of the carrier plate 220 relative to the intermediate plate 230 and, on the other hand, an adjustment of the intermediate plate 230 relative to the base plate 210, in which the carrier plate 220 is moved along with the intermediate plate 230.

As can be further seen in FIGS. 15, 17 and 18, the adjustment arrangement 200 has two base holders 240, 250 attached to the base plate 210, in each of which a sliding element 260 is received in a sliding element receptacle 241 so as to be displaceable in one of the adjustment directions x, y.

The carrier plate 220 is thereby displaceably held on the intermediate plate 230 in a first positioning direction x, while the intermediate plate 230 is displaceably held on the base plate 210 in a second positioning direction y. As shown in FIGS. 15 and 17, elongated holes 221 extending in the first adjusting direction x are provided for the displaceable mounting of the carrier plate 220 on the intermediate plate 230 in the first adjusting direction x, in which bolts 201 provided with a mushroom head and fastened to the intermediate plate 230 are received.

Accordingly, the base holders 240, 250 have bolts 246, 256 on their side facing the intermediate plate 230, which are received in elongated holes 231 of the intermediate plate 230, which extend in the second positioning direction y, in order not to hinder a displacement of the intermediate plate in the second positioning direction relative to the base plate 210.

Similar to the levers 150, 160 or the latching element 170 of the first embodiment, the sliding elements 260 have a receptacle 261 for inserting the auxiliary tool 9.

The sliding element 260 received in the first base holder 240 is fixedly coupled to the intermediate plate 230 and the sliding element 260 received in the second base holder 250 is fixedly coupled to the carrier plate 220.

This makes it possible for the intermediate plate 230 or the carrier plate 220 to be displaced by moving the respective sliding element 260.

For stationary fixing of the sliding elements 260 to the intermediate plate 230 or the carrier plate 220, the sliding elements 260 have at least one web or webs 262, in the embodiment example shown two, aligned perpendicularly to the intended adjusting direction x, y, which projects or project positively in a web receptacle 222, 232 of the intermediate plate 230 or the carrier plate 220.

The web receptacles 222, 232 are formed as elongated hole-shaped recesses in the carrier plate 220 or the intermediate plate 230.

As shown in FIG. 17, the web receptacles 232 of the intermediate plate 230 are preferably integrally formed in an area 233 of the intermediate plate 230 that is slightly raised relative to the rest of the surface of the intermediate plate 230, so as to lie in a recess 244 of the first base holder 240 in the assembled state, in which it is guided in the second positioning direction y by side edges 245 of the recess 244.

Furthermore, the sliding elements 260 preferably have a clamping web 263 which projects into a clamping device 270 received in the respective base holder 240.

This clamping device 270 has two ball carriers 271, each with a ball 272 held therein. Depending on the configuration, however, more than two balls 272 can also be arranged in one ball carrier 271.

The ball carriers 271 with the respective ball 272 fixed to the ball carrier 271 are held displaceably in the respective positioning direction x, y in a respective recess 242, 252 of the base holder 240, 250, shown by way of example in FIG. 18 using the first base holder 240.

One of the base holders 240, 250, in this case the base holder 250, is preferably formed in two parts, with a first part held on the base plate 210, into which a second part 255 can be inserted, the recesses 252 being formed in the second part 255.

The balls 272 are each mounted in a conical section 243, 253 of the respective recess 242, 252 and can be moved by sliding the ball carriers 271 from a spring-loaded clamping position clamping the clamping web 263 of the respective sliding element 260 to a release position not clamping the clamping web 263 of the respective sliding element 260.

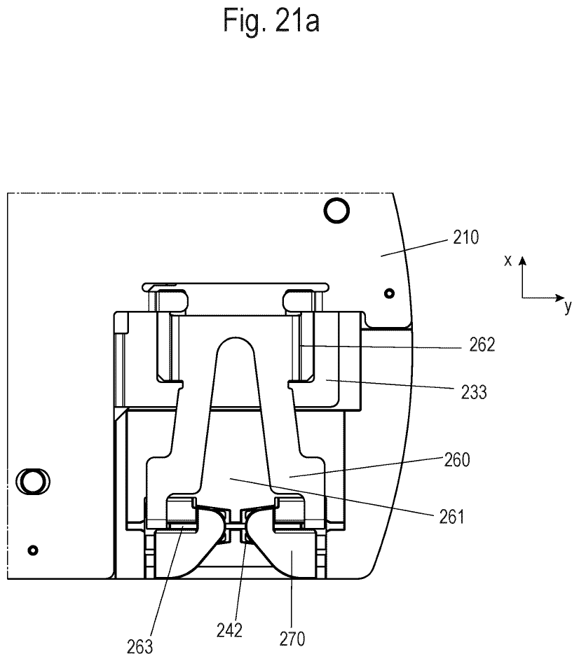

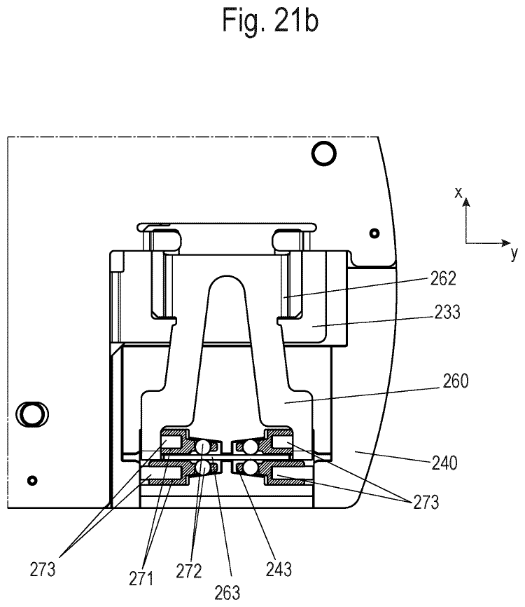

As can be seen in particular in FIG. 18 and FIGS. 21b, 22b, 23b, 24b and 25b, the ball carriers 271 are moved away from each other in the direction of the longitudinal extension of the clamping web 263 in order to release the clamping web 263.

The recesses 242, 252 of each of the base holders 240, 250 are formed in pairs and mirror-symmetrically to a central imaginary mirror axis aligned perpendicular to the longitudinal direction of the clamping web 263.

This arrangement of the recesses 242, 252 has the advantage that the ball carriers 271 can be moved from the clamping position to the release position by inserting the auxiliary tool 9 into the receptacle 261 of the sliding element 260 and, after removing the auxiliary tool 9 from the receptacle 261 of the sliding element 260, can be moved spring-loaded from the release position back to the clamping position.

As shown in FIG. 18 as an example, spring elements 273, in particular in the form of compression springs, are provided for spring loading, which are accommodated in receptacles provided for this purpose in the ball carriers 271 and are supported on the one hand on an inner wall within the receptacle of the ball carrier 271 and on the other hand on a rear wall of the respective recess 242, 252 extending perpendicularly to the actuating direction x, y, so that the ball carriers 271 are always pressed into the clamping position by the force of the spring element 273.

In an alternative embodiment, it is also conceivable to use other clamping bodies with corresponding clamping body carriers instead of the ball carriers 271 with balls 272 accommodated therein.

Cylinders, rollers, sliders or wedges, which are held in appropriately designed clamping element carriers, are particularly conceivable as clamping elements.

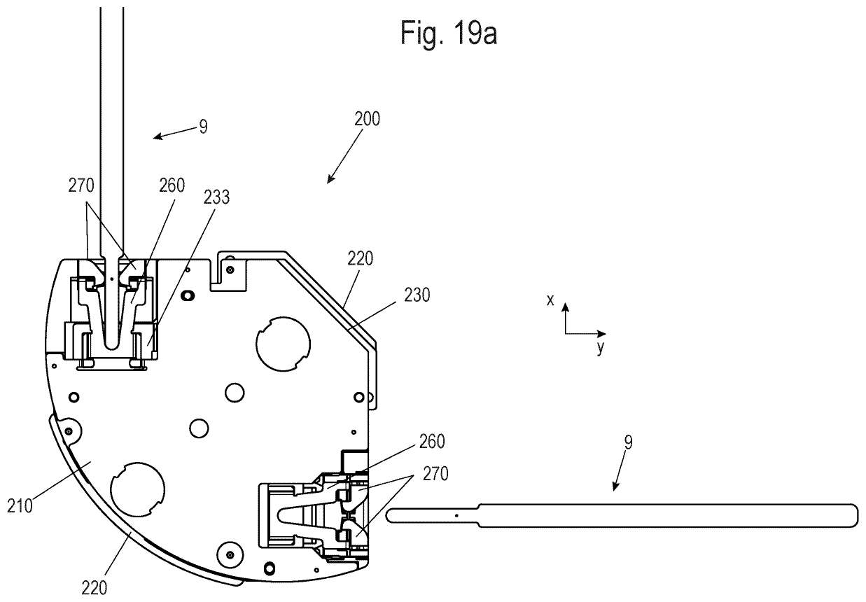

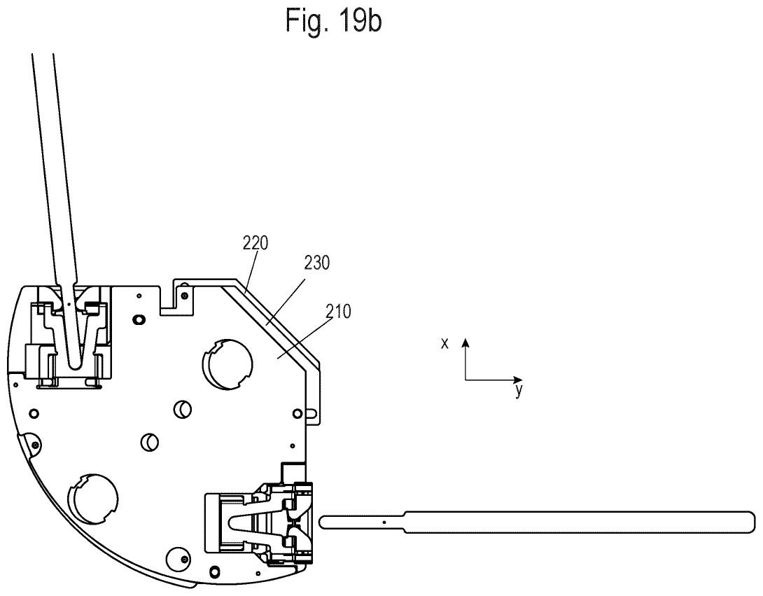

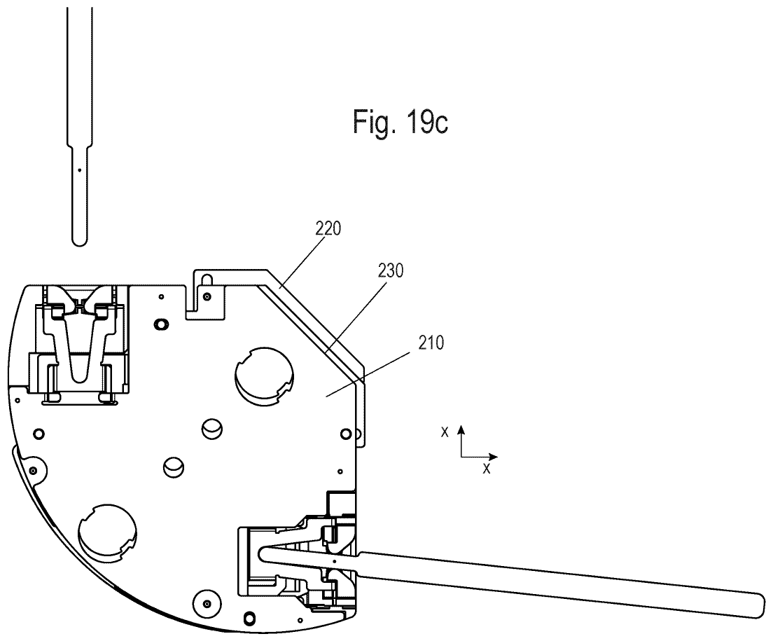

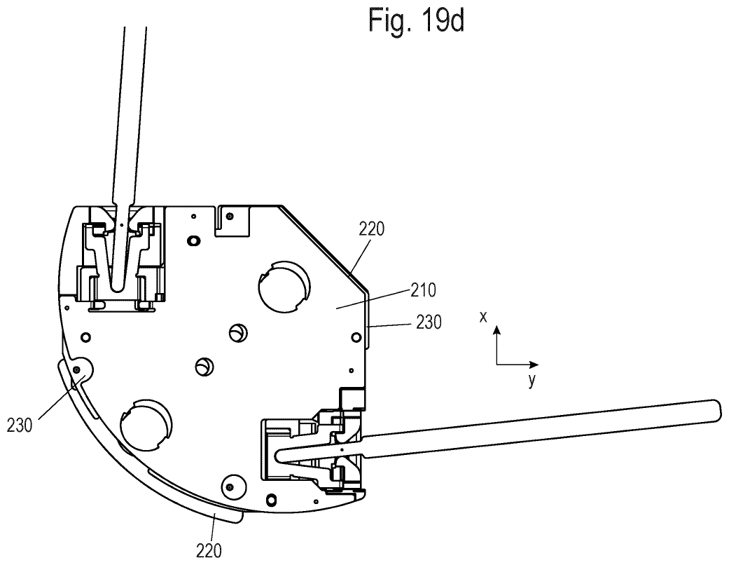

FIG. 19a shows a top view from below of the adjustment arrangement 200, in which one of the two auxiliary tools 9 is inserted into the receptacle 261 of one of the sliding elements 260.

The auxiliary tool 9 is positioned here in a neutral position in the sliding element 260, which is coupled to the intermediate plate 230, so that by pivoting the auxiliary tool 9 a displacement of the intermediate plate and with this of the carrier plate 220 in the second positioning direction y takes place, as can be seen in FIG. 19b.

In a corresponding manner, FIG. 19c shows an adjustment of the carrier plate 220 in adjustment direction x only and FIG. 19d shows an adjustment of the carrier plate 220 in adjustment direction x and additionally an adjustment of the carrier plate 220 together with the intermediate plate 230 in adjustment direction y.

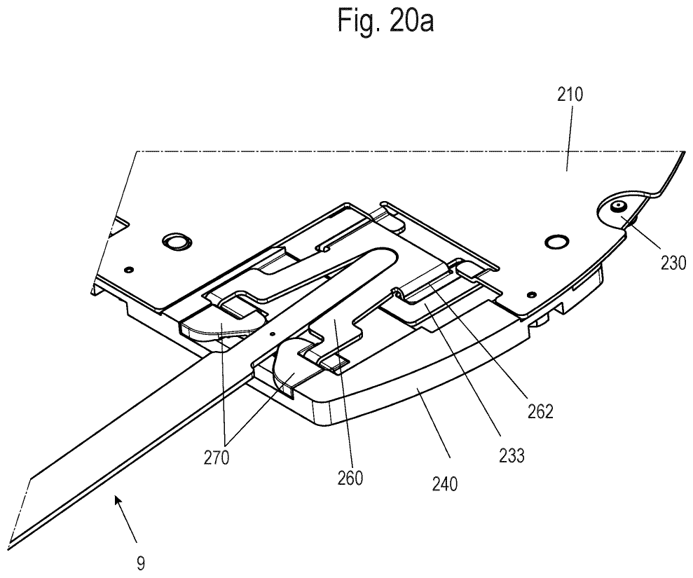

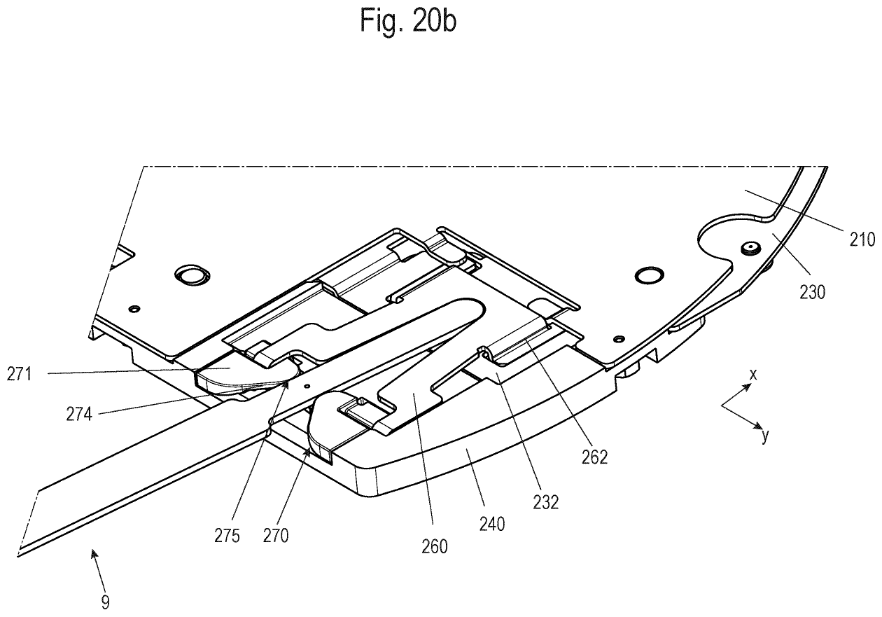

As further shown in FIGS. 20a and 20b, the ball carriers 271 of the clamping device 270, in addition to holding the clamping balls 272, also serve as a stop or pivot point of the auxiliary tool 9 used as a lever, in order to enable the carrier plate 220 to be adjusted with as little force as possible.

For this purpose, the ball carriers 271 have insertion chamfers 274 in order to facilitate the insertion of the actuating tongue 91 of the auxiliary tool 9 and the pushing apart of the clamping devices 270 arranged in pairs.

The insertion chamfers 274 are adjoined by an approximately circular section-shaped pivot point region 275, against which side edges of the actuating tongue 91 abut and which form the pivot point when the auxiliary tool 9 is pivoted in the plane spanned by the actuating directions x, y, with which a displacement of the respective sliding element 260 and thus of the intermediate plate 230 and/or the carrier plate 220 is effected.

FIGS. 21a, 21b to 25a, 25b illustrate the release of the sliding element 260 associated with the sliding movement by the displacement of the ball carriers 271 and with these of the balls 272 held by the ball carriers 271.

FIG. 21a shows the sliding element 260 in a neutral position before displacement of the intermediate plate in the adjusting direction y or against the adjusting direction y and the clamping device 270 consisting of the two ball carriers 271 in the clamping position, in which the clamping web 263 of the sliding element 260 is clamped by the balls 272 and thus prevents unintentional or accidental displacement in or against the adjusting direction y.

FIG. 21b shows a partial sectional view illustrating the four balls 272 clamping the clamping web 263, which are advanced by the spring elements 273 into the conical section 243, 253 of the respective recess 242, 252 to such an extent that they clamp the clamping web 263.

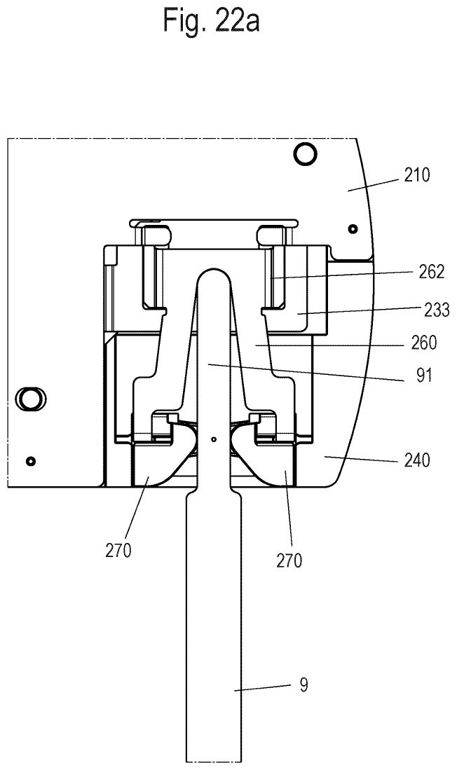

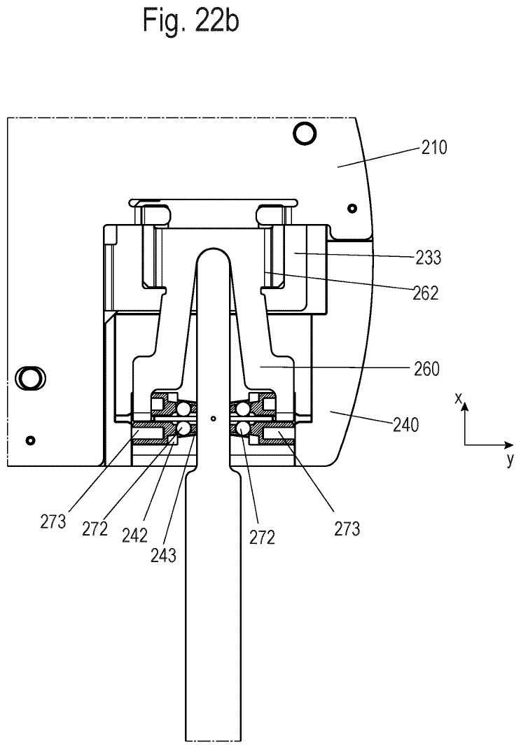

FIGS. 22a and 22b show the auxiliary tool 9 inserted into the receptacle 261 of the sliding element 260 in the neutral position.

As can be clearly seen here, the ball carriers 271 are moved into the release position by the insertion of the auxiliary tool 9.

As can be seen in FIG. 22b, the balls 272 are moved into the further widened area of the conical section 243, so that the clamping web 263 is no longer clamped by the balls 272 and does not hinder an intended sliding movement of the sliding element 260.

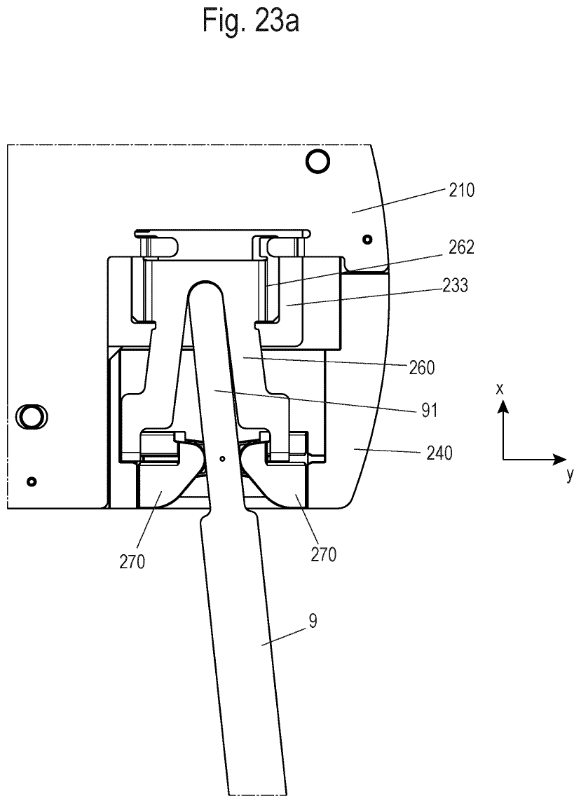

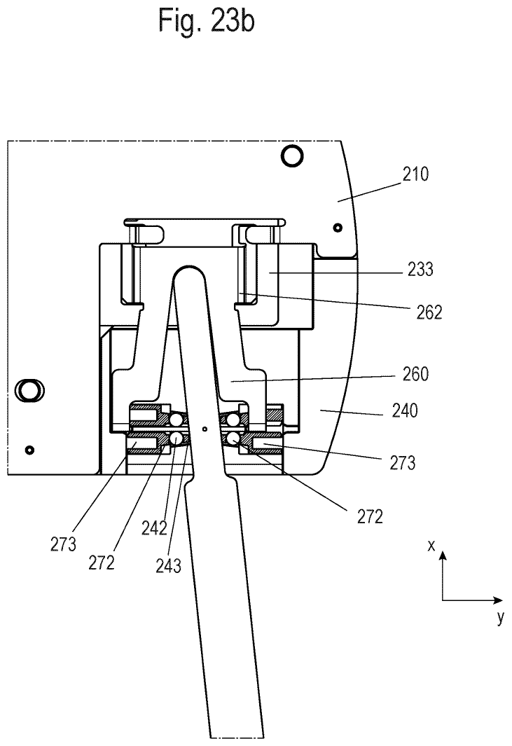

FIGS. 23a and 23b show a sliding element 260 displaced in the opposite direction to the actuating direction y.

As can be seen in FIG. 23b, the balls 272 are still in the release position that does not clamp the clamping web 263.

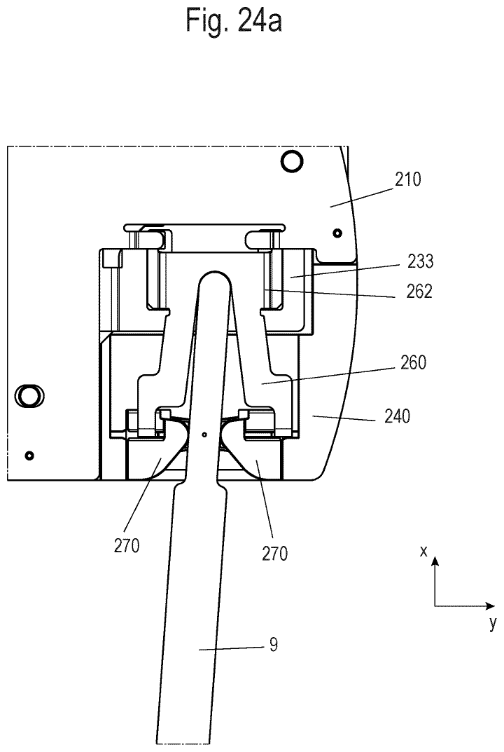

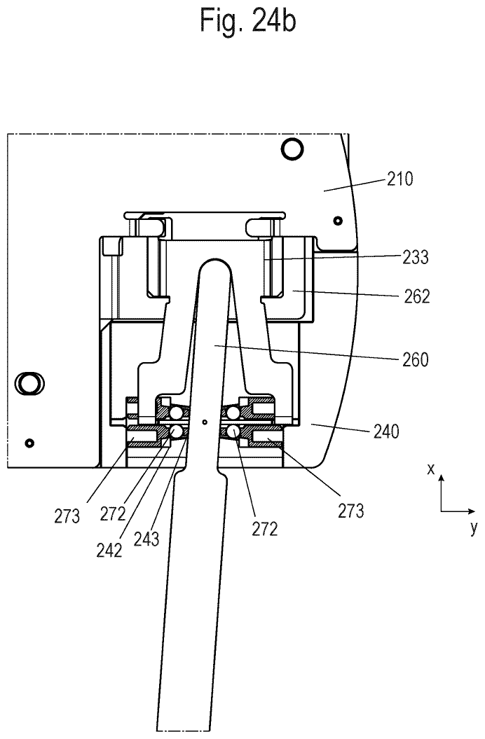

FIGS. 24a and 24b show a representation corresponding to FIGS. 23a and 23b with sliding element 260 displaced in the actuating direction y.

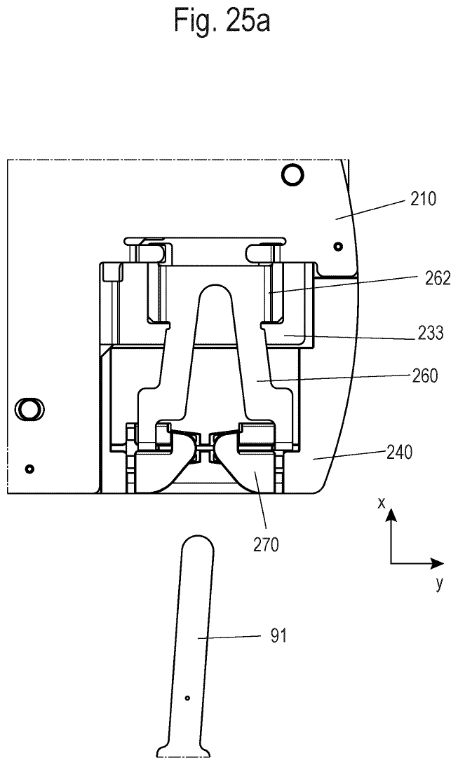

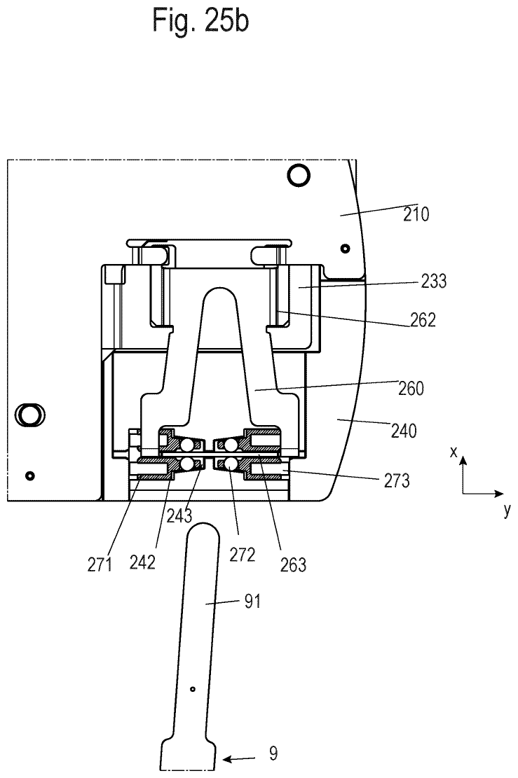

FIGS. 25a and 25b show a sliding element 260 displaced in the adjusting direction y after removal of the auxiliary tool 9 from the receptacle 261 of the sliding element 260.

As can be seen in particular in FIG. 25b, by removing the auxiliary tool 9, the balls 272 together with the ball carriers 271 have been pressed back into the clamping position, in which the clamping web 263 is held in its current position, by the spring force of the spring elements 273.

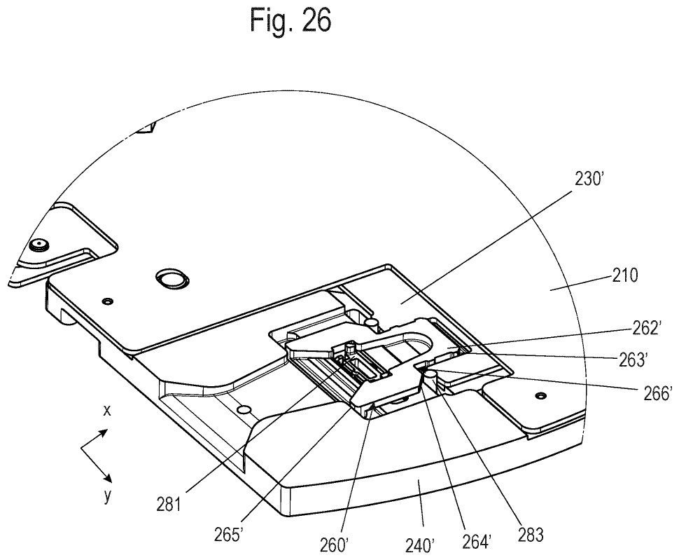

FIGS. 26 to 31 show another alternative embodiment concerning the locking of the sliding element 260′.

In this embodiment, the head 262′ of the sliding element 260′ projects into a recess 231′ of the intermediate plate 230′ with a width adapted to the intended positioning direction x, y, with the parallel side edges 263′ of the head 262′ of the sliding element 260′ abutting the side edges of the intermediate plate 230.

Accordingly, the carrier plate 220 is also designed with a web or head receptacle instead of the two web mounts (not shown here).

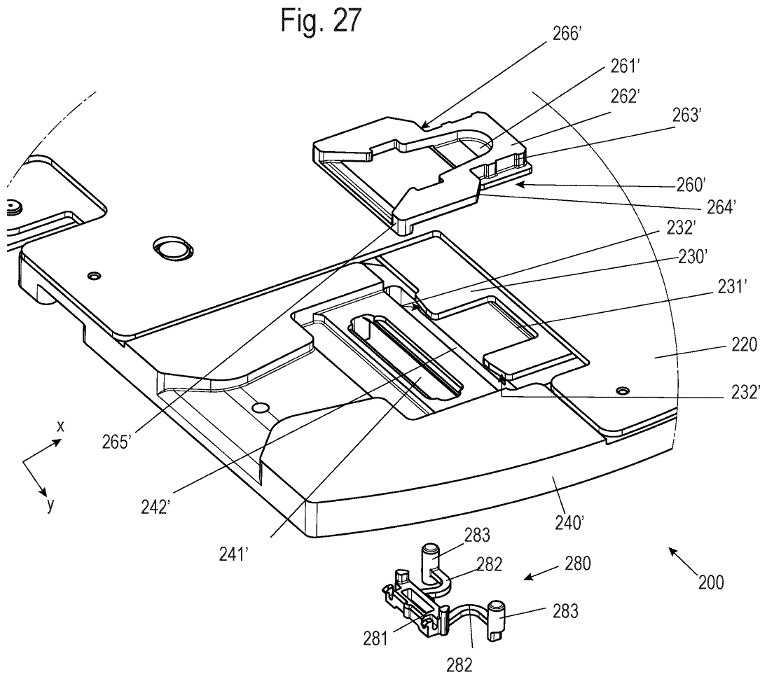

The sliding element 260′ is clamped here by a clamping element 280, as shown as an example in FIG. 27.

This clamping element 280 has a base body 281 lying in a clamping element receptacle 241′ of the base holder 240′ extending in the adjusting direction x, y, from which two curved arms 282 extend, at the ends of which clamping sleeves 283 are formed, which in the mounted state are positioned on both sides of the head 262′ of the sliding element 260′ and projecting into a groove 242′ parallel to the clamping element receptacle 241′ of the base holder 240′.

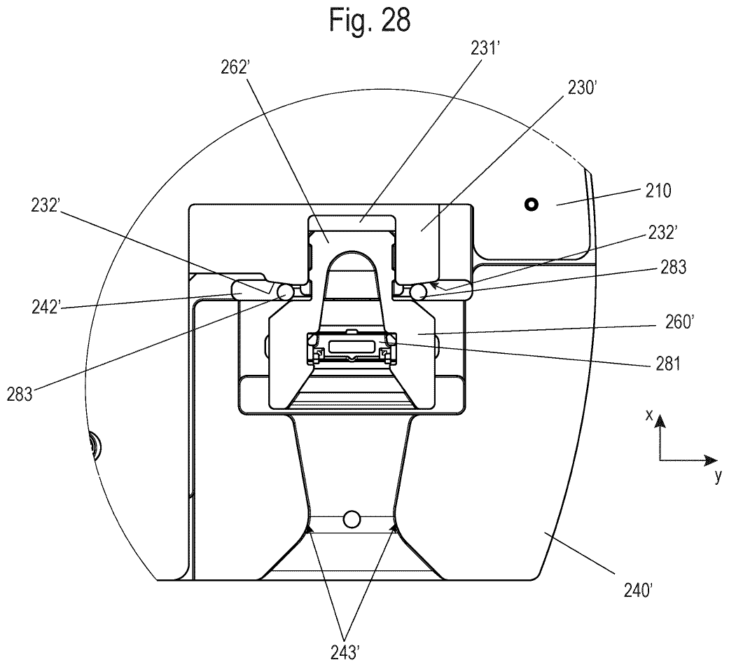

In the clamping position, as shown as an example in FIG. 28, the clamping sleeves 283 rest between a shoulder 266′ of the sliding element 260′ and conical clamping surfaces 232′ outside the recess 231′ of the intermediate plate 230′, so that the sliding element 260′ and the clamping sleeves 283 prevent the intermediate plate 230 from being displaced in the adjusting direction x, y.

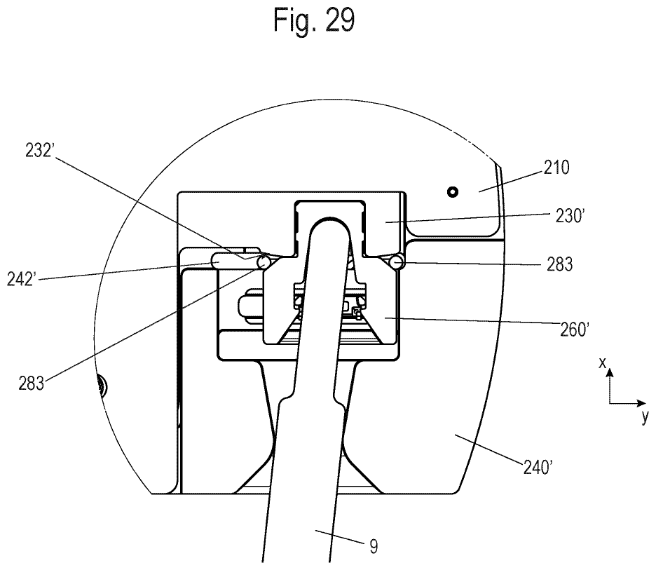

To release this clamping, as shown in FIG. 29, the sliding element 260 is pushed further into the recess of the intermediate plate 230′ by inserting the auxiliary tool 9 in a direction perpendicular to the intended positioning direction x, y.

As a result, the clamping sleeves 283 are pushed outwards away from the shoulder 266′ of the sliding element 260′ via a beveled area 264′ and thus out of the clamping area between the side edge of the groove 242′ of the base holder 240′ and the conical clamping surfaces 232′ clamping the clamping sleeves 283 into a widened area, in which the clamping sleeves 283 are pressed through the widened space between the side edge of the groove 242′ of the base holder 240′ and the conical clamping surfaces 232′ clamping the clamping sleeves 283, whereby the clamping of the intermediate plate 230′ and the sliding element 260′is released.

FIG. 29 already shows a sliding element 260′ adjusted in positioning direction y.

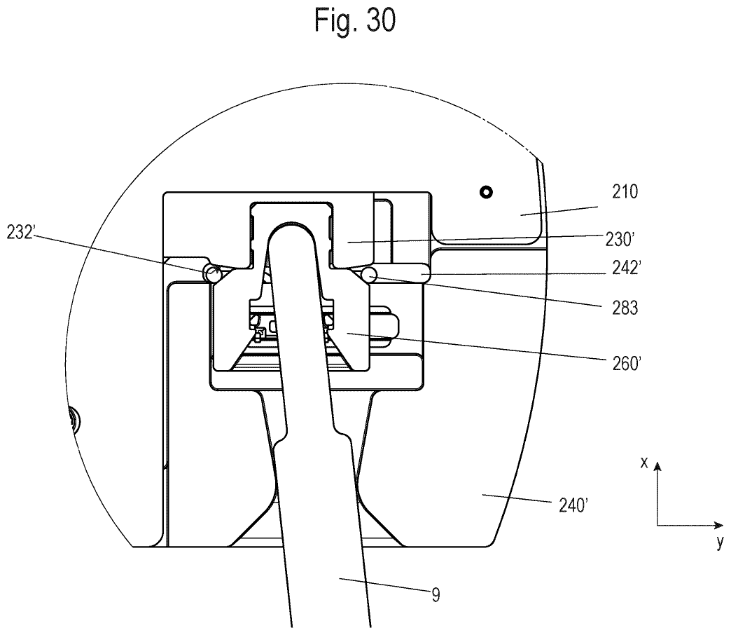

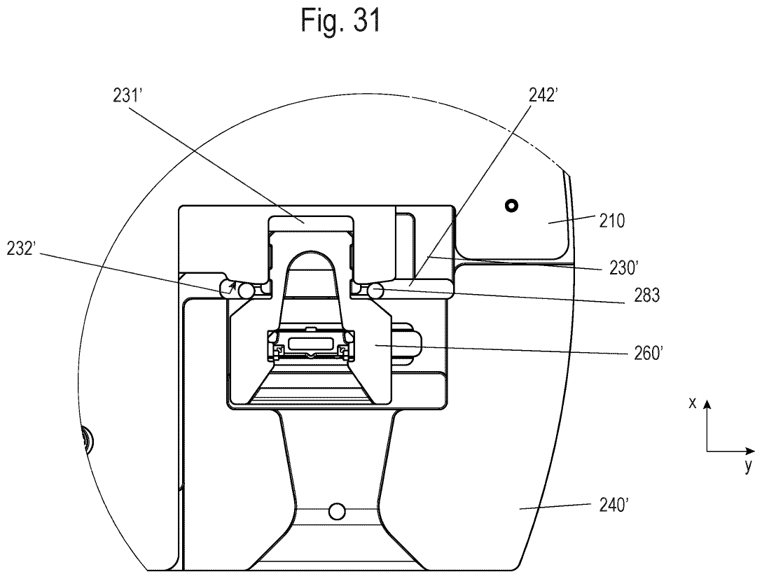

FIG. 30 shows a sliding element 260′ displaced against the adjusting direction y and FIG. 31 shows the sliding element displaced according to FIG. 30 with the auxiliary tool removed, in which the sliding element 260′ is pushed back into the clamping position by the spring force of the spring arms 282 of the clamping element 280.

The pivot points for the auxiliary tool 9 are formed here by the inner edges of the base holder 240′, which are further together.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### List of Reference Symbols

1 Furniture or household appliance element
2 First body
21 Base
22 Ceiling
3 Second body
31 Front or side panel
4,4′ Translational-rotational fitting
41,41′ First fitting part
42, 42′ Second fitting part
43 Rolling element cage
44 Rolling elements
45 Linear guide
46 Guide track
47 Swivel head
5 Slot
9 Auxiliary tool
91 Actuating tongue
92 Handle
93 Folding mechanism
100 Adjustment arrangement
110 Base plate
11 Slider receptacle
112 Elongated hole
113 Latching tooth
114 Pivot pin
120 Carrier plate
121 Driver web
122 Elongated hole
130 First slider
131 Pivot pin
132 Elongated hole
133 Latching tooth
140 Second slider
141 Driver web
142 First leg
143 Second leg
144 Tongue
145 Elongated hole
146 Elongated hole
147 Bore
150 First lever
151 Receptacle
152 Elongated hole
153 Pin receptacle
160 Second lever
161 Receptacle
162 Elongated hole
163 Bolt receptacle
170 Latching element
171 Latching strip
180 Guide bolt
200 Adjustment arrangement
210 Base plate
220 Carrier plate
222 Web receptacle
230 Intermediate plate
231 Slotted hole
232 Web receptacle
233 Elevated area
230′ Intermediate plate
231′ Recess
232′ Clamping surface
240 First base holder
241 Sliding element receptacle
242 Recess
243 Conical section
244 Recess
245 Side edge
246 Bolt
240′ First base holder
241′ Clamping element receptacle
242′ Groove
250 Second base holder
252 Recess
253 Conical section
255 Second part
256 Bolt
260 Sliding element
261 Receptacle
262 Web
263 Clamping web
260′ Sliding element
261′ Receptacle
262′ Head
263′ Side edge
264′ Area
265′ Edge
266′ Shoulder
270 Clamping device
271 Ball carrier
272 Ball
273 Spring element
274 Insertion chamfer
275 Pivot point region
280 Clamping element
281 Base body
282 Spring arm
283 Clamping sleeve
x Adjustment direction
y Adjustment direction
z Direction
R1, R2 Direction of rotation
A Direction of translation

1-21. (canceled)

22. A translational-rotational fitting configured to at least partially positively guide simultaneous translational-rotational movement of a first body relative to a second body in one of two possible opposite directions of rotation and in a predetermined direction of translation, the translational-rotational fitting comprising:
a first fitting part coupled to the first body;
a second fitting part coupled to the second body and movable simultaneously in translation and rotation relative to the first fitting part; and
at least one adjustment arrangement arranged on the first fitting part and operable with an auxiliary tool to independently align the first fitting part relative to the first body in at least one of first and second mutually perpendicular adjustment directions in a plane of the plane spanned by the predetermined direction of translation and the directions of rotation by a limited adjustment amount.

23. The translational-rotational fitting of claim 22, wherein the at least one adjustment arrangement comprises:
a base plate arranged on the first body; and
a carrier plate arranged on the first fitting part.

24. The translational-rotational fitting of claim 23, wherein the at least one adjustment arrangement further comprises:
a first slider held displaceably in a receptacle of the base plate in the second adjustment direction;
a second slider coupled to the first slider and arranged displaceable relative to the base plate in the second adjustment direction;
a first lever coupled in a stationary but pivotable manner to the first slider to adjust the carrier plate relative to the base plate in the first adjustment direction;
a second lever coupled in a stationary but pivotable manner to the base plate to adjust the carrier plate relative to the base plate in the second adjustment direction; and
a plurality of guide bolts held stationary on the second slider, wherein the plurality of guide bolts extend through elongated holes of the base plate extending in the second adjustment direction into elongated holes of the carrier plate extending in the first adjustment direction,
wherein the first lever and the second lever each have a receptacle configured for insertion or fixing the auxiliary tool.

25. The translational-rotational fitting of claim 24, wherein, to lock the adjustment arrangement, the first lever is latchable by a latching element on the first slider or the second lever is latchable by a latching element on the base plate.

26. The translational-rotational fitting of claim 25, wherein the latching element is resiliently mounted in a region of the respective receptacle of the first and second lever.

27. The translational-rotational fitting of claim 26, wherein on the first slider and in a region of the base plate on which the receptacle of the second lever for inserting the auxiliary tool is positioned, latching teeth are integrally formed, which can be brought into engagement with latching teeth of a latching strip of the latching element, wherein the latching strip is out of engagement with the latching teeth on the first slider when the auxiliary tool is pushed into the receptacle of the first or second lever.

28. The translational-rotational fitting of claim 23, wherein the adjustment arrangement further comprises:
an intermediate plate arranged between the base plate and the carrier plate; and
two base holders fastened to the base plate, wherein a sliding element is accommodated in each of the two base holders so as to be displaceable in one of the first and second adjustment directions,
wherein the carrier plate is held on the intermediate plate so as to be displaceable in a first of the adjusting directions and the intermediate plate is held on the base plate so as to be displaceable in a second of the adjusting directions,
wherein the sliding elements of the two base holders each have a receptacle configured for inserting or fixing the auxiliary tool,
wherein the sliding element received in a first one of the two base holders is coupled in a stationary manner to the intermediate plate or the carrier plate, and
wherein the sliding element received in a second one of the two base holders is coupled in a stationary manner to the other of one the intermediate plate or the carrier plate.

29. The translational-rotational fitting of claim 28, wherein the sliding elements of the two base holders each have at least one web aligned perpendicularly to one of the first and second adjustment directions and projecting positively into a web receptacle of the intermediate plate or of the carrier plate.

30. The translational-rotational fitting of claim 28, wherein the sliding elements of the two base holders each have a clamping web projecting into a clamping device received in a respective one of the two base holders.

31. The translational-rotational fitting of claim 30, wherein each of the clamping devices has two ball carriers each with a ball held in the respective ball carrier, wherein the two ball carriers are held displaceably in a respective one of the first and second adjusting directions in a respective recess of the base holder, wherein the balls are each mounted in a conical section of the respective recess and are moveable in a spring-loaded manner from a clamping position clamping the clamping web of the respective sliding element into a release position not clamping the clamping web of the respective sliding element by displacing the two ball carriers.

32. The translational-rotational fitting of claim 30, wherein each of the clamping devices has two clamping body carriers, wherein both of the two clamping body carriers have a clamping body held therein, wherein the clamping bodies are held displaceably in the respective one of the first and second adjusting directions in a respective recess of the base holder, wherein the clamping bodies are each mounted in a conical section of the respective recess and are moveable in a spring-loaded manner from a clamping position clamping the clamping web of the respective sliding element into a release position not clamping the clamping web of the respective sliding element by displacing the clamping body carriers.

33. The translational-rotational fitting of claim 32, wherein the clamping bodies are cylinders, rollers, sliding pieces, or wedges.

34. The translational-rotational fitting of claim 28, the sliding elements are clampable to the base holder by a clamping element, wherein the clamping element is held in a clamping element receptacle of the base holder so as to be displaceable in one of the first and second adjustment directions and the sliding element clamps against a groove of the base holder in a direction perpendicular to the one of the first and second adjustment directions in a pressing manner.

35. The translational-rotational fitting of claim 24, wherein the auxiliary tool has an actuating tongue configured to be pushed into the receptacles.

36. The translational-rotational fitting of claim 35, wherein the actuating tongue of the auxiliary tool is configured to be pushed into the respective receptacle and pulled out of the respective receptacle again.

37. The translational-rotational fitting of claim 35, wherein the actuating tongue of the auxiliary tool inserted into the respective receptacle is fixed in the respective receptacle.

38. The translational-rotational fitting of claim 37, wherein the actuating tongue of the auxiliary tool is coupled to a handle via a folding mechanism.

39. The translational-rotational fitting of claim 22, wherein the first and second fitting parts are fitting plates which, for the simultaneous translational-rotational movement, each have running grooves in mutually facing bearing surfaces in which rolling elements are guided.

40. The translational-rotational fitting of claim 22, further comprising:
a guide element arranged on the first fitting part configured to guide the simultaneous translational-rotational movement, wherein the guide element is moveable in a curved guide track arranged on or in the second fitting part.

41. A furniture or household appliance element comprising:
a first body;
a second body moveable relative to the first body; and
a translational-rotational fitting configured to move the second body relative to the first body in a predetermined direction of translation and simultaneously in one of first and second opposite directions of rotation,
a first fitting part coupled to the first body;
a second fitting part coupled to the second body and movable simultaneously in translation and rotation relative to the first fitting part; and
at least one adjustment arrangement arranged on the first fitting part and operable with an auxiliary tool to independently align the first fitting part relative to the first body in at least one of first and second mutually perpendicular adjustment directions in a plane of the plane spanned by the predetermined direction of translation and the directions of rotation by a limited adjustment amount.

42. The furniture or household appliance element of claim 41, wherein a front or side panel of the second body is arranged on the second body in such a way that the auxiliary tool for actuating the adjustment arrangement is accessible via a slot between an upper or lower edge of the front or side panel and a base or a ceiling of the first body in a closed position of the second body.
